(19) United States
(12) Patent Application Publication
(10) Pub. No.: US 2005/0158518 A1
(43) Pub. Date: Jul. 21, 2005

(54) VERTICALLY STACKED CARDED WEB STRUCTURE WITH SUPERIOR INSULATION PROPERTIES

(75) Inventor: Arun Pal Aneja, Greenville, NC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: Invista North America S.a r.l., Wilmington, DE (US)

(21) Appl. No.: 11/015,950

(22) Filed: Dec. 16, 2004

Related U.S. Application Data
(60) Provisional application No. 60/532,225, filed on Dec. 23, 2003.

(51) Int. Cl. B32B 3/28

(52) U.S. Cl. 428/167

(57) ABSTRACT

A vertically stacked carded web structure having an area density in a range from 60 to 500 gm/m², a height of in a range from 5 mm to 40 mm and a peak frequency which occurs in a range from 4 to 24 times per inch exhibits superior insulating properties.

### CROSS-REFERENCE TO RELATED APPLICATION

This application claims benefit of priority from Provisional Application No. 60/532,225 filed Dec. 23, 2003.

### FIELD OF THE INVENTION

The present invention is directed to a vertically stacked carded web structure useful as filling material with superior insulating properties.

### BACKGROUND OF THE INVENTION

Polyester fiberfill filling material (sometimes referred to herein as polyester fiberfill) has become well accepted as a reasonably inexpensive filling and/or insulating material especially for pillows, and also for cushions and other furnishing materials, including other bedding materials, such as sleeping bags, mattress pads, quilts and comforters and including duvets, and in apparel, such as parkas and other insulated articles of apparel, because of its bulk filling power, aesthetic qualities and various advantages over other filling materials, so is now manufactured and used in large quantities commercially. Bulk is an essential requirement for fiberfill. Slickeners, referred to in the art and hereinafter, are preferably applied to improve aesthetics. As with any product, it is preferred that the desirable properties not deteriorate during prolonged use; this is referred to generally as durability. Hollow polyester fibers have generally been preferred over solid filaments, and improvements in our ability to make hollow polyester fiberfill with a round periphery has been an important reason for the commercial acceptance of polyester fiberfill as a preferred filling material. Examples of prior cross-sections are those with a single longitudinal void, such as disclosed by Tolliver, U.S. Pat. No. 3,772,137, and by Glanzstoff, GB 1,168,759, and multi-void fibers, including those with 4-holes, such as disclosed in EPA 2 67,684 (Jones and Kohli), and those with 7-holes, disclosed by Broaddus, U.S. Pat. No. 5,104,725, all of which have been used commercially as hollow polyester fiberfill filling material. Most commercial filling material has been used in the form of cut fibers (often referred to as staple) but some filling material, including polyester fiberfill filling material, has been used in the form of deregistered tows of continuous filaments, as disclosed, for example by Watson, U.S. Pat. Nos. 3,952,134, and 3,328,850. We use herein both terms “fiber” and “filament” inclusively without intending use of one term to exclude the other. Marcus in U.S. Pat. No. 4,618,531 has directed to providing refluffable fiber balls (sometimes referred to in the trade as “clusters”) of randomly arranged, entangled, spirally crimped polyester fiberfill. Aneja in U.S. Pat. No. 6,602,581 B2 has directed to providing corrugated fiberfill structures for filling with particular application directed toward compression/recovery related applications such as pillows and a process for making the same.

### SUMMARY OF THE INVENTION

The present invention solves the problem associated with the prior art by providing articles which have desired performance of insulation with reduced weight, i.e., enhanced warmth to weight ratio at superior economic terms. Applicant has found that such performance is achieved by a combination of certain structure properties of bulk density, height and peak frequency. Moreover, applicant has found that such performance is achieved when such structures are made from fibers with certain denier per filament, crimp per inch and crimp take-up. Applicant has measured performance in vertically stacked structures in terms of warmth to weight ratio. Insulation is determined by the parameter CLO. One CLO will allow passage of one kilo calorie per square meter per hour with a 0 18° C. temperature gradient. Higher CLO reflects more insulation. The parameter of sample weight is defined by area density measured in grams per square meter. Hence the units of warmth to weight ratio are CLO/(g/m²).

Therefore, in accordance with the present invention there is provided a vertically stacked carded web structure having a lengthwise rectangular cross-section with continuous parallel ridges and grooves of approximately equal spacing wherein said web structure has an area density in a range from 60 to 500 gm/m², a height of in a range from 5 mm to 40 mm and a peak frequency which occurs in a range from 4 to 24 times per inch. The structure comprises fiberfill fibers with a denier per filament of about 0.5 to about 30 (0.55-33 decitex per filament), crimps per inch of about 6 to about 15, and a crimp take-up of about 25% to about 35%.

### BRIEF DESCRIPTION OF DRAWINGS

FIG. 1 is a diagram illustrating performance of warmth to weight ratio of the invention versus commercially available products used as “Control”.

### DETAILED DESCRIPTION OF A PREFERRED EMBODIMENT OF THE INVENTION

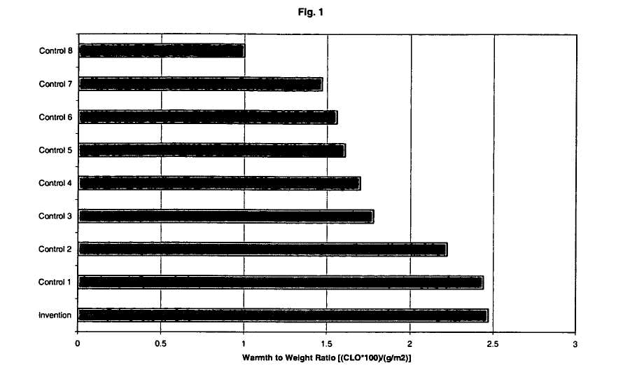

With reference to the drawing of FIG. 1, which illustrates the performance of the present invention relative to control, the present invention provides vertically stacked carded web structures with superior insulation properties.

Properties of the individual fibers (before being formed into structures) desirable in the manufacture of the final corrugated fiberfill structure of the present invention include denier per filament, crimp frequency, and crimp take-up. Denier is defined as the weight in grams of 9000 meters of fiber and is thus a measure in effect of the thickness of the fiber which makes up the structure. Crimp of a fiber is exhibited by numerous peaks and valleys in the fiber. Crimp frequency is measured as the number of crimps per inch (cpi) or crimps per centimeter (cpcm) after the crimping of a tow. It has been found, through extensive testing, that fibers having a denier per filament of about 0.5 to about 30 (0.55-33 decitex per filament), crimps per inch of about 6 to about 15, and a crimp take-up of about 25% to about 35% are particularly useful for the corrugated fiberfill structure of the present invention.

Fibers from a wide variety of both addition and condensation polymers can be used to form the corrugated fiberfill structures of the present invention. Typical of such polymers are: polyhydrocarbons such as polyethylene, polypropylene and polystyrene; polyethers such as polyformaldehyde; vinyl polymers such as polyvinyl chloride and polyvinylidene fluoride; polyamides such as polycaprolactam and polyhexamethylene adipamide; polyurethanes such as the polymer from ethylene bischloroformate and ethylene diamine; polyesters such as polyhydroxypivalic acid and poly (ethylene terephthalate); copolymers such as poly(ethylene terephthalate-isophthalate) and their equivalents.

Preferred materials are polyesters, including poly(ethylene terephthalate), poly(propylene terephthalate), poly(butylene terephthalate), poly(1,4-cyclohexylene-dimethylene terephthalate) and copolymers thereof. Most or all of the polymers useful as fiber materials according to the present invention can be derived from recycled materials. The fiberfill can be formed from any desired polyester, such as, for example, homopolymers, copolymers, terpolymers, and melt blends of monomers made from synthetic, thermoplastic polymers, which are melt-spinnable.

Alternatively, the fiberfill can be formed from para-aramids, which are used to make aramid fibers sold under the trade KEVLAR® by E. I. du Pont de Nemours and Company of Wilmington, Del. (hereinafter “DuPont”), or meta-aramids, which are used to make aramid fibers sold under the trademark NOMEX® by DuPont.

Important features of the corrugated fiberfill structure of the present invention, which have been predetermined by extensive testing, are bulk density, height and peak frequency. Specifically, the corrugated fiberfill structure of the present invention should have an area density of about 60 to about 500 g/m², a height of about 10 mm to about 40 mm, and a peak frequency which occurs at about 4 to about 25 times per inch.

According to the present invention, criteria for obtaining superior performance from vertically stacked carded web structure was defined. Performance is defined in terms of ratio of insulation provided divided by the area density of the sample.

### Test Method

The insulation characteristics of the samples were measured using ASTM-C518 test procedure. The insulation characteristic defined as CLO was divided by the area density of the sample to obtain the warmth to weight ratio of a square unit of the sample.

Crimp frequency was measured by removing ten filaments from a tow bundle at random and positioned (one at a time) in a relaxed state in clamps of a fiber-length measuring device. The clamps were manually operated and initially moved close enough together to prevent stretching of the fiber while placing it in the clamp. One end of a fiber was placed in the left clamp and the other end in the right clamp of the measuring device. The left clamp was rotated to remove any twist in the fiber. The right clamp support was moved slowly and gently to the right (extending the fiber) until all the slack has been removed from the fiber but without removing any crimp. Using a lighted magnifier, the number of peaks and the number of valleys of the fiber were counted. The right clamp support was then moved slowly to the right until all the crimp had just disappeared. Care was taken not to stretch the fiber. This length of the fiber was recorded. The crimp frequency (cpi, the metric equivalent being cpcm) for each filament was calculated as:

$$\frac{Total Number of Nodes of Peak and Valley}{2 \times Length of Filament ( uncrimped )}$$

The average of the ten measurements of all ten fibers was recorded for the cpi or cpcm.

CTU (crimp take-up) was also measured on tow and is a measure of the length of the tow extended, so as to remove the crimp, divided by the unextended length (i.e., as crimped), expressed as a percentage, as described in Anderson, et. Al. U.S. Pat. No. 5,219,582.

### EXAMPLES

### Example 1

Poly(ethylene terephthalate) staple fiber from bales is fed to a picker. The fiber blend consists of the following components: (i) Poly(ethylene terephthalate) (3.0 dpf, 8.5 cpi, 30.3% ctu and 1.5-inch cut length) and (ii) Unitika binder fiber MELTY 4080 Type S74 (4.0 dpf, 1-inch cut length). The relative concentration by weight is 82% PET, and 18% fiber binder. The opened-up fiber mixture was well-blended in an air-conveyed blender to form a uniform mixture. The well-blended fiber mixture was carded to form a fibrous web. Carding machine operating at thruput rate of 400 meters per minute while the card doffer was operating at a speed of 100 feet per minute. The well-blended, uniform card web was then converted into the vertically stacked structure comprising a plurality of continuous alternating peaks and valleys of the present invention. The accordion-like arrangement of the structure which extends in alternately different directions between each peak and each valley was formed by the driving mechanism reciprocating element, moving up and down vertically. The vertically folded structure immediately entered into an oven and exited at a speed of 19 feet per minute. The oven was maintained at 375° F. to bond and consolidate the structure to maintain its vertical stacking. The structure height was 24.13 mm, with an area density of 89 g/m² and a peak frequency of 6 peaks/inch. The structure height may be reduced if necessary by applying pressure and heat.

A 12″×12″ sample of the structure was evaluated for insulative performance. The structure performance characteristics of insulation were measured using ASTM-C518 test. The warmth to weight ratio was calculated to be 2.47 (CLO×100)/(g/m²).

Control

Eight different items were evaluated as control. All these items are commercially available fiberfill material used for insulation presently. The items are listed in Table I.

TABLE I

| Control | Trade Name | Specification |
|---|---|---|
| I | Thermolite Extreme | Dual denier slick fibers (6.5 dpf, 3 |
| | | void hollow @ 30% + 1.5 dpf |
| | | round @ 70%) |
| II | Thermolite Extra | 6 dpf, 3 void hollow, spiral crimp, |
| | | high loft bicomponent, slick |
| III | Thermolite Micro | 0.9 dpf round blend of 55% slick, |
| | | 27% dry and 18% binder |
| IV | Thermolite Plus | 3.6 dpf hollow round @ 55%, 1.65 |
| | | dpf round at 27% and 18% binder |
| V | Qualofil | 5.5 dpf, 7 hole hollow, round, |
| | | mechanically crimped, slick |
| VI | Hollofil II | 6.5 dpf, 4-hole hollow, round, |
| | | mechanically crimped, slick |
| VII | Hollofil 808 | 6.5 dpf, 4-hole hollow, round, |
| | | mechanically crimped, dry |
| VIII | Thermolite Active | 1.65 dpf, round, mechanically |
| | | crimped, 55% slick, 27% dry and |
| | | 18% binder |

The performance superiority of the invention versus control is shown in FIG. 1.

### Example II

Vertically folded structures were made substantially the same as in Example I except with different fiber and structure properties. The structures are evaluated for performance of warmth to weight ratio using ASTM-C518 test. The results are listed in Table II.

TABLE II

| | | | Nodes | Thick- | Area | Warmth to Weight |
|---|---|---|---|---|---|---|
| | | | Per | ness | Density | Ratio [(CLO × |
| Dpf | CPI | CTU | Inch | (mm) | (g/m²) | 100)/(g/m²)] |
| 6.0 | 8.5 | 28.5 | 13 | 16.26 | 80.7 | 2.06 |
| 6.5 | 11 | 34 | 5.5 | 11.43 | 67.81 | 1.95 |
| 6.5 | 11 | 34 | 9.7 | 11.68 | 67.81 | 1.99 |
| 3.0 | 8.5 | 30.3 | 6 | 20.57 | 100 | 2.21 |
| 3.0 | 8.5 | 30.3 | 6 | 37.85 | 145 | 2.29 |

1. A vertically stacked carded web structure having a lengthwise rectangular cross-section with continuous parallel ridges and grooves of approximately equal spacing wherein said web structure has an area density in a range from 60 to 500 gm/m², a height of in a range from 5 mm to 40 mm and a peak frequency which occurs in a range from 4 to 24 times per inch.

2. The vertically stacked carded web structure of claim 1, further including 0 to 20 parts by weight of binder.

3. The vertically stacked carded web structure of claim 1, where the structure comprises fiberfill fibers with a denier per filament of about 0.5 to about 30, crimps per inch of about 6 to about 15 and crimp take-up of about 25% to about 35%.

4. The vertically stacked carded web structure of claim 1, wherein the vertical stacking in the web is fixed by attachment to supporting structures on either one or both sides of the web.

5. The vertically stacked carded web structure of claim 4 wherein the web is physically attached to the supporting structure.

6. The vertically stacked carded web structure of claim 1 wherein:
the area density is in a range from 65 to 150 gm/m²;
the height is in a range from 15 to 25 mm; and
the peak frequencies are in a range from 6 to 24 times per inch.

7. An article of heat insulation comprising the vertically stacked carded web structure of claim 1.

8. The vertically stacked carded web structure of claim 1, wherein the warmth to weight ratio of the structure is 1.5-2.5 (CLO×100)/g/m²).
